(19) United States
(12) Patent Application Publication
(10) Pub. No.: US 2021/0010527 A1
(43) Pub. Date: Jan. 14, 2021

(54) CONNECTION STRUCTURE OF BOLT AND NUT WITH DUMBBELL SHAPE BIDIRECTIONAL TAPERED THREAD HAVING SMALL LEFT TAPER AND LARGE RIGHT TAPER

(71) Applicant: AMICUS VERITATIS MACHINERY CO., LTD., Taizhou (CN)

(72) Inventor: Yihua YOU, TAIZHOU (CN)

(21) Appl. No.: 17/036,240

(22) Filed: Sep. 29, 2020

Related U.S. Application Data
(63) Continuation of application No. PCT/CN2019/081392, filed on Apr. 4, 2019.

(30) Foreign Application Priority Data
Apr. 7, 2019 (CN) 201810303107.1

(51) Int. Cl. F16B 39/30; F16B 33/02; F16B 35/04

(52) U.S. Cl. CPC F16B 39/30; F16B 35/04; F16B 33/02

(57) ABSTRACT

The disclosure relates to the general technology of devices, and in particular relates to a connection structure of bolt and nut with dumbbell shape bidirectional tapered thread having small left and large right taper. The disclosure solves the problems of poor self-positioning and poor self-locking of existing thread. The disclosure is characterized that an internal thread (6) is a bidirectional tapered hole (41) in an inner surface of a cylindrical body (2) (non-solid space) and an external thread (9) is a bidirectional truncated cone body (71) in an the outer surface of a columnar body (3) (material entity), and each of the complete unit threads thereof is a dumbbell-like shape (94) bidirectional conical body with a left-side taper (95) smaller than a right-side taper (96) in the form of a helical and having a small middle and two large ends.

### CROSS-REFERENCE TO RELATED APPLICATIONS

This application is a continuation of International Patent Application No. PCT/CN2019/081392, filed on Apr. 4, 2019, entitled “CONNECTION STRUCTURE OF BOLT AND NUT WITH DUMBBELL SHAPE BIDIRECTIONAL TAPERED THREAD HAVING SMALL LEFT TAPER AND LARGE RIGHT TAPER,” which claims priority to China Patent Application No. 201810303107.1, filed on Apr. 7, 2018. The content of these identified applications are hereby incorporated by references.

### TECHNICAL FIELD

The disclosure relates to the field of general technology of device, and particularly relates to a connection structure of bolt and nut with dumbbell shape bidirectional tapered thread having small left and large right taper, which can also be called a connection structure of bolt and nut with dumbbell-like shape (the taper on the left is smaller than the taper on the right) asymmetric bidirectional tapered thread.

### BACKGROUND

The invention of thread has a profound impact on the progress of human society. Thread is one of the most basic industrial technologies. It is not a specific product, but a key generic technology in the industry. It has the technical performance that must be embodied by specific products as application carriers, and is widely applied in various industries. The existing thread technology has high standardization level, mature technical theory and long-term practical application. It is a fastening thread when used for fastening, a sealing thread when used for sealing, and a transmission thread when used for transmission. According to the thread terminology of national standards, the “thread” refers to thread bodies having the same thread profile and continuously protruding along a helical line on a cylindrical or conical surface; and the “thread body” refers to a material entity between adjacent flanks. This is also the definition of thread under global consensus.

The modem thread began in 1841 with British Whitworth thread. According to the theory of modern thread technology, the basic condition for self-locking of the thread is that an equivalent friction angle shall not be smaller than a helical rise angle. This is an understanding for the thread technology in modern thread based on a technical principle-“principle of inclined plane”, which has become an important theoretical basis of the modern thread technology. Simon Stevin was the first to explain the principle of inclined plane theoretically. He has researched and discovered the parallelogram law for balancing conditions and force composition of objects on the inclined plane. In 1586, he put forward the famous law of inclined plane that the gravity of an object placed on the inclined plane in the direction of inclined plane is proportional to the sine of inclination angle. The inclined plane refers to a smooth plane inclined to the horizontal plane; the helix is a deformation of the “inclined plane”; the thread is like an inclined plane wrapped around the cylinder, and the flatter the inclined plane is, the greater the mechanical advantage is (see FIG. 8) (Jingshan Yang and Xiuya Wang, Discussion on the Principle of Screws, Disquisitiones Arithmeticae of Gauss).

The “principle of inclined plane” of the modern thread is an inclined plane slider model (see FIG. 9) which is established based on the law of inclined plane. It is believed that the thread pair meets the requirements of self-locking when a thread rise angle is less than or equal to the equivalent friction angle under the condition of little change of static load and temperature. The thread rise angle (see FIG. 10), also known as thread lead angle, is an angle between a tangent line of a helical line on a pitch-diameter cylinder and a plane perpendicular to a thread axis; and the angle affects the self-locking and anti-loosening of the thread. The equivalent friction angle is a corresponding friction angle when different friction forms are finally transformed into the most common inclined plane slider form. Generally, in the inclined plane slider model, when the inclined plane is inclined to a certain angle, the friction force of the slider at this time is exactly equal to the component of gravity along the inclined plane; the object is just in a state of force balance at this time; and the inclination angle of the inclined plane at this time is called the equivalent friction angle.

American engineers invented the wedge thread in the middle of last century; and the technical principle of the wedge thread still follows the “principle of inclined plane”. The invention of the wedge thread was inspired by the “wooden wedge”. Specifically, the wedge thread has a structure that a wedge-shaped inclined plane forming an angle of 25°-30° with the thread axis is located at the root of internal threads (i.e., nut threads) of triangular threads (commonly known as common threads); and a wedge-shaped inclined plane of 300 is adopted in engineering practice. For a long time, people have studied and solved the anti-loosening and other problems of the thread from the technical level and technical direction of thread profile angle. The wedge thread technology is also a specific application of the inclined wedge technology without exception.

The modern threads are abundant in types and forms, and are all tooth-shaped threads, which are determined by the technical principle, i.e., the principle of inclined plane. Specifically, the thread formed on a cylindrical surface is called cylindrical thread; the thread formed on a conical surface is called conical thread; and the thread formed on an end surface of the cylinder or the truncated cone is called plane thread. The thread formed on the surface of an outer circle of the body is called external thread; the thread formed on the surface of an inner round hole of the body is called internal thread; and the thread formed on the end surface of the body is called end face thread. The thread that the helical direction and the thread rise angle direction conform to the left-hand rule is called left-hand thread; and the thread that the helical direction and the thread rise angle direction conform to the right-hand rule is called right-hand thread. The thread having only one helical line in the same cross section of the body is called single-start thread; the thread having two helical lines is called double-start thread; and the thread having multiple helical lines is called multi-start thread. The thread having a triangular cross section is called triangular thread; the thread having a trapezoidal cross section is called trapezoidal thread; the thread having a rectangular cross section is called rectangular thread; and the thread having a zigzag cross section is called zigzag thread.

However, the existing threads have the problems of low connection strength, weak self-positioning ability, poor self-locking performance, low bearing capacity, poor stability, poor compatibility, poor reusability, high temperature and low temperature and the like. Typically, bolts or nuts using the modern thread technology generally have the defect of easy loosening. With the frequent vibration or shaking of equipment, the bolts and the nuts become loose or even fall off, which easily causes safety accidents in serious cases.

### SUMMARY

Any technical theory has theoretical hypothesis background; and the thread is not an exception. With the development of science and technology, the damage to connection is not simple linear load, static or room temperature environment; and linear load, nonlinear load and even the superposition of the two cause more complex load damaging conditions and complex application conditions. Based on such recognition, the object of the present disclosure is to provide a connection structure of bolt and nut with bidirectional tapered thread with reasonable design, simple structure, and excellent connection performance and locking performance with respect to the above problems.

To achieve the above object, the following technical solution is adopted in the present disclosure: the connection structure of bolt and nut with dumbbell-like shape (the taper on the left is smaller than the taper on the right) asymmetric bidirectional tapered thread is composed of an asymmetric bidirectional conical internal thread and an asymmetric bidirectional conical external thread, and both of them are used to form the thread connection pair. It is a special thread pair technology that combines the technology characteristics of the cone pair and the helical motion. The bidirectional tapered thread is a thread technology which combine the bidirectional cone and the helical structure technical characteristics. The bidirectional cone is composed of two single cones. The left and right tapers face each other and the taper of the left is smaller than the right, and they are composed bidirectionally. The bidirectional cone is spirally distributed on the outer surface of the columnar body to form an external thread and/or the aforementioned bidirectional cone is spirally distributed on the inner surface of the cylindrical body to form an internal thread. Regardless of the internal thread or the external thread, the complete unit thread is a dumbbell-like shape special bidirectional conical geometry with a small middle and big ends, and the taper on the left is smaller than the taper on the right.

For the bolt and nut with the bidirectional tapered thread, the definition of the dumbbell-like shape asymmetric bidirectional tapered thread can be expressed as: “On a cylindrical or conical surface, the asymmetric bidirectional tapered hole (or asymmetric bidirectional truncated cone body) has prescribed right taper and left taper, and the left and right taper have an opposite direction, and the left taper is smaller than the right. The dumbbell-like shape special bidirectional tapered geometry is continuously and/or discontinuously distributed along the helical line in a helical shape with a small middle and big ends at both ends.” Due to manufacturing reasons, the head and tail of an asymmetric thread may be incomplete bidirectional conical geometry. Different from the modern thread technology, the thread technology has changed from original engagement relationship of modern internal thread and external thread to the engagement relationship of this bidirectional tapered thread internal thread and external thread.

The bolt and nut with the bidirectional tapered thread comprise a bidirectional truncated cone body helically distributed on an outer surface of a columnar body and a bidirectional tapered hole helically distributed on an inner surface of a cylindrical body. Namely, the bidirectional tapered thread technology comprises an external thread and an internal thread which are in mutual thread fit. The internal thread is the helically distributed bidirectional tapered hole; and the external thread is the helically distributed bidirectional truncated cone body. The internal thread is presented by the helical bidirectional tapered holes and in the form of a “non-entity space”; and the external thread is presented by the helical bidirectional truncated cone body and in the form of a “material entity”. The non-entity space refers to a space environment capable of accommodating the above material entity. The internal thread is a containing part; and the external thread is a contained part. The threads work in such a state that the internal thread and the external thread are fitted together by screwing the two bidirectional tapered geometries pitch by pitch, and the internal thread is cohered with the external thread till one side bears the load bidirectionally or both the left side and the right side bear the load bidirectionally at the same time or till the external thread and the internal thread are in interference fit. Whether the two sides bear bidirectional load at the same time is related to the actual working conditions in the application field. The bidirectional tapered hole contains and is fitted with the bidirectional truncated cone body pitch by pitch, i.e., the internal thread is fitted with the corresponding external thread pitch by pitch.

The thread connection pair is a thread pair formed by fitting a helical outer conical surface with a helical inner conical surface to form a cone pair. In the bidirectional tapered thread, both the outer conical surface of the external cone body and the inner conical surface of the internal cone body are bidirectional conical surfaces. When the thread connection pair is formed between the bidirectional tapered threads, a joint surface between the inner conical surface and the outer conical surface is used as a bearing surface; when the thread connection pair is formed between the bidirectional tapered thread and the traditional thread, a joint surface between the conical surface of the bidirectional tapered thread and the special conical surface of the traditional thread is used as a bearing surface. Namely, the conical surface is used as the bearing surface to realize the technical performance of connection. The self-locking, self-positioning, reusability, fatigue resistance and other capabilities of the thread pair mainly depend on size of the conical surfaces and taper of the cone pair forming the bidirectional tapered thread technology, i.e., the size of the conical surface and the taper of the internal thread and the external thread. The thread pair is a non-toothed thread.

Different from that the principle of inclined plane of the existing thread which shows a unidirectional force distributed on the inclined plane as well as an engagement relationship between the internal tooth bodies and the external tooth bodies, for the bolt and nut with bidirectional tapered thread, threaded body, that is, the bidirectional conical body, is composed of two plain lines of the cone body in two directions (i.e. bidirectional state) when viewed from any cross section of the single cone body distributed on either left or right side along the cone axis. The plain line is the intersection line of the conical surfaces and a plane through which the cone axis passes through. The cone principle of the bidirectional tapered thread technology shows an axial force and a counter-axial force, both of which are combined by bidirectional forces, wherein the axial force and the corresponding counter-axial force are opposite to each other. The internal thread and the external thread are in a cohesion relationship. Namely, the thread pair is formed by cohering the external thread with the internal thread, i.e., the tapered hole (internal cone) is cohered with the corresponding tapered cone body (external cone body) pitch by pitch till the self-positioning is realized by cohesion fit or till the self-locking is realized by interference contact. Namely, the self-locking or self-positioning of the internal cone body and the external cone body is realized by radially cohering the tapered hole and the truncated cone body to realize the self-locking or self-positioning of the thread pair, rather than the thread connection pair, composed of the internal thread and the external thread in the traditional thread, which realizes its connection performance by mutual abutment between the tooth bodies.

A self-locking force will arise when the cohesion process between the internal thread and the external thread reaches certain conditions. The self-locking force is generated by a pressure produced between an axial force of the internal cone and a counter-axial force of the external cone. Namely, when the internal cone and the external cone form the cone pair, the inner conical surface of the internal cone body is cohered with the outer conical surface of the external cone body; and the inner conical surface is in close contact with the outer conical surface. The axial force of the internal cone and the counter-axial force of the external cone are concepts of forces unique to the bidirectional tapered thread technology, i.e., the cone pair technology, in the present disclosure.

The internal cone body exists in a form similar to a shaft sleeve, and generates the axial force pointing to or pressing toward the cone axis under the action of external load. The axial force is bidirectionally combined by a pair of centripetal forces which are distributed in mirror image with the cone axis as a center and are respectively perpendicular to two plain lines of the cone body; i.e., the axial force passes through the cross section of the cone axis and is composed of two centripetal forces which are bidirectionally distributed on two sides of the cone axis in mirror image with the cone axis being the center, are respectively perpendicular to the two plain lines of the cone body, and point to or press toward a common point of the cone axis; and the axial force passes through a cross section of a thread axis and is composed of two centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The axial force is densely distributed on the cone axis and/or the thread axis in an axial and circumferential manner, and corresponds to an axial force angle, wherein the axial force angle is formed by an angle between two centripetal forces forming the axial force and depends on the taper of the cone body, i.e., the taper angle.

The external cone body exists in a form similar to a shaft, has relatively strong ability to absorb various external loads, and generates a counter-axial force opposite to each axial force of the internal cone body. The counter-axial force is bidirectionally combined by a pair of counter-centripetal forces which are distributed in mirror image with the cone axis as the center and are respectively perpendicular to the two plain lines of the cone body; i.e., the counter-axial force passes through the cross section of the cone axis and is composed of two counter-centripetal forces which are bidirectionally distributed on two sides of the cone axis in mirror image with the cone axis as the center, are respectively perpendicular to the two plain lines of the cone body, and point to or press toward the common point of the cone axis; and the counter-axial force passes through the cross section of the thread axis and is composed of two counter-centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The counter-axial force is densely distributed on the cone axis and/or the thread axis in the axial and circumferential manner, and corresponds to a counter-axial force angle, wherein the counter-axial force angle is formed by an angle between the two counter-centripetal forces forming the counter-axial force and depends on the taper of the cone body, i.e., the taper angle.

The axial force and the counter-axial force start to be generated when the internal cone and the external cone of the cone pair are in effective contact, i.e., a pair of corresponding and opposite axial force and counter-axial force always exist during the effective contact of the internal cone and the external cone of the cone pair. The axial force and the counter-axial force are bidirectional forces bidirectionally distributed in mirror image with the cone axis and/or the thread axis as the center, rather than unidirectional forces. The cone axis and the thread axis are coincident axes, i.e., the same axis and/or approximately the same axis. The counter-axial force and the axial force are reversely collinear and are reversely collinear and/or approximately reversely collinear when the cone body and the helical structure are combined into the thread and form the thread pair. The internal cone and the external cone are engaged till interference is achieved, so the axial force and the counter-axial force generate a pressure on the contact surface between the inner conical surface and the outer conical surface and are densely and uniformly distributed on the contact surface between the inner conical surface and the outer conical surface axially and circumferentially. When the cohesion movement of the internal cone and the external cone continues till the cone pair reaches the pressure generated by interference fit to combine the internal cone with the external cone, i.e., the pressure enables the internal cone body to be engaged with the external cone body to form a similar integral structure and will not cause the internal cone body and the external cone body to separate from each other under the action of gravity due to arbitrary changes in a direction of a body position of the similar integral structure after the external force caused by the pressure disappears. The cone pair generates self-locking, which means that the thread pair generates self-locking. The self-locking performance has a certain degree of resistance to other external loads which may cause the internal cone body and the external cone body to separate from each other except gravity. The cone pair also has the self-positioning performance which enables the internal cone and the external cone to be fitted with each other. The above pressure is essential for the cone pair to generate self-locking, is mainly related to the conical surface and taper size of the conical bodies forming the cone pair, and also has some relationship to an external load borne by the inner and outer conical bodies while forming the cone pair. Further, under an action condition of a rated external load, i.e., when the external load borne by the inner and outer conical bodies of the cone pair forming the above thread technology in the present disclosure is an invariant, that is, in a situation or circumstance of the action condition of certain external loads of the same size, the pressure generated between the inner and outer conical bodies forming the cone pair is inversely proportional to tangent of a half taper angle of the cone body, that is, the pressure generated between the inner and outer conical bodies forming the cone pair under the action of the rated external load is inversely proportional to tangent of ½ taper angle, i.e., a half taper angle, of a taper angle corresponding to taper of the above inner and outer conical bodies (that is, internal and external thread bodies in accordance with the technical spirit of the present disclosure). However, not any axial force angle and/or counter-axial force angle may enable the cone pair to produce self-locking and self-positioning.

When the axial force angle and/or the counter-axial force angle is less than 180 and greater than 127°, the cone pair has the self-locking performance. When the axial force angle and/or the counter-axial force angle is infinitely close to 180°, the cone pair has the best self-locking performance and the weakest axial bearing capacity. When the axial force angle and/or the counter-axial force angle is equal to and/or less than 127° and greater than 0, the cone pair is in a range of weak self-locking performance and/or no self-locking performance. When the axial force angle and/or the counter-axial force angle tends to change in a direction infinitely close to 0, the self-locking performance of the cone pair changes in a direction of attenuation until the cone pair completely has no self-locking ability-, and the axial bearing capacity changes in a direction of enhancement until the axial bearing capacity is the strongest.

When the axial force angle and/or the counter-axial force angle is less than 180 and greater than 127°, the cone pair is in a strong self-positioning state, and the strong self-positioning of the internal cone body and the external cone body is easily achieved. When the axial force angle and/or the counter-axial force angle is infinitely close to 180°, the internal cone body and the external cone body of the cone pair have the strongest self-positioning ability. When the axial force angle and/or the counter-axial force angle is equal to and/or less than 127° and greater than 0°, the cone pair is in a weak self-positioning state. When the axial force angle and/or the counter-axial force angle tends to change in the direction infinitely close to 0°, the mutual self-positioning ability of the internal and external cone bodies of the cone pair changes in the direction of attenuation until the cone pair is close to have has no self-positioning ability at all.

Compared technology with the containing and contained relationship of irreversible one-sided bidirectional containment that the unidirectional tapered thread of single cone body invented by the applicant before which can only bear the load by one side of the conical surface, the thread connection pair of the bidirectional tapered thread technology of the present disclosure allows the reversible left and right-sided bidirectional containment of the bidirectional tapered threads of double cone bodies, enabling the left side and/or the right side of the conical surface to bear the load, and/or the left conical surface and the right conical surface to respectively bear the load, and/or the left conical surface and the right conical surface to simultaneously bear the load bidirectionally, and further limiting a disordered degree of freedom between the tapered hole and the truncated cone body; and the helical movement enables the thread connection pair to obtain a necessary ordered degree of freedom, thereby effectively combining the technical characteristics of the cone pair and the thread pair to form a brand-new thread technology.

When bolt and nut with bidirectional tapered thread is used, the conical surface of the bidirectional truncated cone body of the external thread of bidirectional tapered thread matched with the conical surface of the bidirectional tapered hole of the internal thread of bidirectional tapered thread.

For the bolt and nut with bidirectional tapered thread, the bidirectional conical body of the taper pair, that is, the truncated cone body and/or the tapered hole is not realized at any taper or any taper angle of the internal and external bidirectional cone bodies, i.e., the truncated cone body and/or tapered hole of the internal and external bidirectional cone bodies of the bidirectional tapered thread of the bidirectional tapered thread technology. The thread connection pair has the self-locking and self-positioning performances only when the internal cone body and the external cone body reach a certain taper, i.e., the cone bodies of the cone pair forming the present bidirectional tapered thread connection pair reach a certain taper angle. The taper comprises the left taper and the right taper of the internal thread and the external thread. The taper angle comprises a left taper angle and a right taper angle of the internal and external thread bodies. The internal thread and external thread form the connecting structure of bolt and nut with dumbbell-shaped asymmetric bidirectional tapered thread, and the left taper is smaller than the right taper. The left taper corresponds to the left taper angle, that is, the first taper angle α1, preferably 0°<The first taper angle α1<53°, preferably, the first taper angle α1 takes a value of 2°-40°. The right taper corresponds to the right taper angle, that is, the second taper angle α2, preferably 0°<The second taper angle α2<53°, preferably, the second taper angle α2 takes a value of 2-40. In individual special fields, preferably, 53°≤the second taper angle α2<180°, preferably, the second taper angle α2 takes a value of 53°˜90°.

The above-mentioned individual special fields refer to the application fields of thread connection such as transmission connection with low requirements on self-locking performance or even without self-locking performance and/or with low requirements on self-positioning performance and/or with high requirements on axial bearing capacity and/or with indispensable anti-locking measures.

For the bolt and nut with bidirectional tapered thread, the external thread is arranged on the outer surface of the columnar body, wherein a screw body is arranged on the columnar body; the truncated cone body is helically distributed on the outer surface of the screw body, comprising a bidirectional truncated cone body. The truncated cone body includes the asymmetric bidirectional truncated cone body. The columnar body may be solid or hollow, comprising cylindrical and/or non-cylindrical workpieces and objects that need to be machined with threads on outer surfaces thereof, wherein the outer surfaces include cylindrical surfaces, non-cylindrical surfaces such as conical surfaces, and outer surfaces.

For the bolt and nut with bidirectional tapered thread, the asymmetric bidirectional truncated cone body, that is, the external thread, is formed by symmetrically and oppositely jointing upper top surfaces of two truncated cone bodies with the same lower bottom surfaces and upper top surfaces and same cone height and/or different cone heights, and the lower bottom surfaces are located at both ends of the bidirectional truncated cone body to form the bidirectional tapered thread, comprising that the upper top surfaces are respectively jointed with the lower bottom surfaces of the adjacent bidirectional truncated cone bodies and/or to be respectively jointed with the lower bottom surfaces of the adjacent bidirectional truncated cone bodies in the helical shape to form the thread. The external thread comprises a first helical conical surface of the truncated cone body, a second helical conical surface of the truncated cone body and an external helical line, which form the bidirectional tapered external thread. In a cross section through which the thread axis passes, a complete single-pitch bidirectional tapered external thread, is a special bidirectional tapered geometry in the dumbbell-like shape small in the middle and large in both ends. The bidirectional truncated cone body comprises a conical surface of the bidirectional truncated cone body. The angle formed between the two plain lines of the left conical surface of the bidirectional truncated cone body, i.e., the first helical conical surface of the truncated cone body, is the first taper angle α1. The left taper is formed on the first helical conical surface of the truncated cone body and is subjected to a right-direction distribution. The angle formed between the two plain lines of the right conical surface of the bidirectional truncated cone body, i.e., the second helical conical surface of the truncated cone body, is the second taper angle α2. The right taper is formed on the second helical conical surface of the truncated cone body and is subjected to a left-direction distribution. The taper directions corresponding to the first taper angleal and the second taper angle α2 are opposite. The plain line is an intersection line of the conical surface and the plane through which the cone axis passes. A shape formed by the first helical conical surface and the second helical conical surface of the truncated cone body of the bidirectional truncated cone body is the same as a shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the columnar body, wherein the right-angled side is coincident with the central axis of the columnar body, and the right-angled trapezoid union is formed by symmetrically and oppositely jointing upper sides of two right-angled trapezoids with the same lower sides and upper sides and same and/or different right-angled sides. The right-angled trapezoid union refers to a special geometry, which is formed by symmetrically and oppositely jointing the upper sides of two right-angled trapezoids with the same lower sides and upper sides and same and/or different right-angled sides and has the lower sides respectively located at both ends of the right-angled trapezoid union.

For the bolt and nut with bidirectional tapered thread, The internal thread of the bidirectional tapered thread technology is arranged in the inner surface of the cylindrical body, wherein the cylindrical body is provided with a nut body; the tapered hole is helically distributed on the inner surface of the nut body, comprising the bidirectional tapered hole. The bidirectional tapered hole includes the bidirectional tapered hole. The cylindrical body comprises cylindrical and/or non-cylindrical workpieces and objects which need to be machined with the internal threads in inner surfaces thereof, wherein the inner surfaces include geometric shapes of inner surfaces such as cylindrical surfaces, non-cylindrical surfaces such as conical surfaces, and the like.

For the bolt and nut with bidirectional tapered thread, the asymmetric bidirectional tapered hole, that is, the internal thread, is formed by symmetrically and oppositely jointing upper top surfaces of two tapered holes with the same lower bottom surfaces and upper top surfaces and different cone heights, and the lower bottom surfaces are located at both ends of the bidirectional tapered hole to form the bidirectional tapered thread, comprising that the upper top surfaces are respectively jointed with the lower bottom surfaces of the adjacent bidirectional tapered holes and/or to be respectively jointed with the lower bottom surfaces of the adjacent bidirectional tapered holes in the helical shape to form the thread. The internal thread comprises the first helical conical surface of the tapered hole, the second helical conical surface of the tapered hole and the internal helical line, which form the bidirectional tapered internal thread. In the cross section passing through the thread axis, the complete single-pitch bidirectional tapered internal thread, is a special bidirectional tapered geometry in the dumbbell-like shape shape and with a small middle and two large ends. The bidirectional tapered hole comprises a conical surface of the bidirectional tapered hole. The angle formed by the two plain lines of the left conical surface of the bidirectional tapered hole, i.e., the first helical conical surface of the tapered hole, is the first taper angle α1. The left taper is formed on the first helical conical surface of the tapered hole and is subjected to the right-direction distribution. The angle formed by the two plain lines of the right conical surface of the bidirectional tapered hole, i.e., the second helical conical surface of the tapered hole, is the second taper angle α2. The right taper is formed on the second helical conical surface of the tapered hole and is subjected to the left-direction distribution. The taper directions corresponding to the first taper angle α1 and the second taper angle α2 are opposite. The plain line is an intersection line of the conical surface and the plane through which the cone axis passes. A shape formed by the first helical conical surface and the second helical conical surface of the tapered hole of the bidirectional tapered hole is the same as a shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the cylindrical body, wherein the right-angled side is coincident with the central axis of the cylindrical body; and the right-angled trapezoid union is formed by symmetrically and oppositely jointing upper sides of two right-angled trapezoids with the same lower sides and upper sides and same and/or different right-angled sides. The right-angled trapezoid union refers to a special geometry, which is formed by symmetrically and oppositely jointing the upper sides of two right-angled trapezoids with the same lower sides and upper sides and same and/or different right-angled sides and has the lower sides respectively located at both ends of the right-angled trapezoid union.

When the connection structure of the bolt and nut with bidirectional tapered thread works, the relationship with the workpiece includes rigid connection and non-rigid connection. The rigid connection means that the nut supporting surface and the workpiece supporting surface are mutually supporting surfaces, including structural forms such as single nut and double nuts. The non-rigid connection means that the opposite side end surfaces of the two nuts are mutually supporting surfaces and/or there is a spacer between the opposite side faces of two nuts, which are indirectly supporting each other. It is mainly used in non-rigid materials or non-rigid connection workpieces such as transmission parts or application fields such as double nuts installation to meet requirements. The workpiece refers to the connected object including the workpiece. The spacer refers to the spacer including the washer.

For the bolt and nut with bidirectional tapered thread, when the connection structure of bolt and double nuts is used and the relationship with the fastened workpiece is rigidly connected, the threaded working bearing surface is different. When the cylindrical body is located on the left of the fastened workpiece, that is, when the left end face of the fastened workpiece and the right end face of the cylindrical body, that is, the left nut body, are locking supporting surface of the left nut body and the fastened workpiece, the left helical conical surface of the bidirectional tapered thread of the left bolt and columnar body (bolt body or bolt), that is, the first helical conical surface of the tapered hole, and the first helical conical surface of the truncated cone body are supporting surfaces of tapered thread. The first helical conical surface of the tapered hole and the first helical conical surface of the truncated cone body are mutually supporting surfaces. When the cylindrical body is located on the right of the fastened workpiece, that is, when the right end face of the fastened workpiece and the left end face of the cylindrical body, that is, the right nut body, are the locking supporting surfaces of the left nut body and the workpiece, the right helical conical surface of the bidirectional tapered thread of the left bolt and columnar body (bolt body or bolt), that is, the first conical surface of the tapered hole, and the second helical conical surface of the truncated cone body are supporting surface of tapered thread. The second conical surface of the tapered hole and the second helical conical surface of the truncated cone body are mutually supporting surfaces.

For the bolt and nut with bidirectional tapered thread, when the connection structure is bolt with a single nut and they are rigidly connected to the fastened workpiece, if the hexagonal head of the bolt is on the left side, the cylindrical body, that is the nut body or the single nut, is located on the right side of the fastened workpiece. When the connection structure of the bolt and single nut works, the right end surface of the workpiece and the left end surface of the nut body are the locking supporting surfaces of the nut body and the fastened workpiece. The right helical conical surface of the bidirectional tapered thread of the nut body and columnar body (bolt body or blot), that is, the second helical conical surface of the tapered hole, and the second helical conical surface of the truncated cone body are supporting surfaces of tapered thread. The second helical conical surface of the tapered hole and the second helical conical surface of the truncated cone body are mutually supporting surfaces. If the hexagonal head of the bolt is on the right side, the cylindrical body, that is the nut body or the single nut, is located on the left side of the fastened workpiece. When connection structure of the bolt and single nut works, the left end surface of the workpiece and the right end surface of the nut body are the locking supporting surfaces of the nut body and the fastened workpiece. The left helical conical surface of the bidirectional tapered thread of the nut body and columnar body (bolt body or bolt), that is, the first helical conical surface of the tapered hole, and the first helical conical surface of the truncated cone body are supporting surfaces of tapered thread. The first helical conical surface of the tapered hole and the first helical conical surface of the truncated cone body are mutually supporting surfaces.

For the bolt and nut with bidirectional tapered thread, when the connection structure is the bolt with double nuts and they are non-rigidly connected to the fastened workpiece, the threaded working supporting surface, that is, the tapered thread supporting surface, is different. The cylindrical body includes the left nut body and the right nut body. The right end surface of the left nut body and the left end surface of the right nut body are in direct contact with each other and are mutually locking supporting surfaces. When the right end surface of the left nut body is the locking supporting surface, the left helical conical surface of the bidirectional tapered thread of the left nut body and columnar body (bolt body or bolt), that is, the first helical conical surface of the tapered hole, and the first helical conical surface of the truncated cone body are supporting surfaces of tapered thread. The first helical conical surface of the tapered hole and the first helical conical surface of the truncated cone body are mutually supporting surfaces. When the left end surface of the right nut body is the locking supporting surface, the right helical conical surface of the bidirectional tapered thread of the right nut body and columnar body (bolt body or bolt), that is, the second helical conical surface of the tapered hole, and the second helical conical surface of the truncated cone body are supporting surfaces of tapered thread. The second helical conical surface of the tapered hole and the second helical conical surface of the truncated cone body are mutually supporting surfaces.

For the bolt and nut with bidirectional tapered thread, when the connection structure is bolt with double nuts and they are non-rigidly connected to the fastened workpiece, the threaded working supporting surface, that is, the tapered thread supporting surface is different. The cylindrical body includes the left nut body and the right nut body, and there is a spacer between the left nut body and the right nut body. The right end surface of the left nut body and the right end surface of the left nut body are in indirect contact with each other through the spacer and indirectly are mutually locking supporting surfaces. When the cylindrical body is on the left side of the spacer and the left end surface of the right nut body is the locking supporting surface, the left helical conical surface of the bidirectional tapered thread of the nut body and columnar body (bolt body or bolt), that is, the first helical conical surface of the tapered hole, and the first helical conical surface of the truncated cone body are supporting surfaces of tapered thread. The first helical conical surface of the tapered hole and the first helical conical surface of the truncated cone body are mutually supporting surfaces. When he cylindrical body is on the right side of the spacer and the left end surface of the right nut body is the locking supporting surface, the right helical conical surface of the bidirectional tapered thread of the nut body and columnar body (bolt body or bolt), that is, the second helical conical surface of the tapered hole, and the second helical conical surface of the truncated cone body are supporting surfaces of tapered thread. The second helical conical surface of the tapered hole and the second helical conical surface of the truncated cone body are mutually supporting surfaces.

For the bolt and nut with bidirectional tapered thread, when the connection structure is the bolt with double nuts and they are non-rigidly connected to the fastened workpiece, when the inner cylindrical body, that is, the nut body adjacent to the fastened workpiece, has been effectively combined with the columnar body (bolt body or bolt), and in other words, when the internal thread and the external thread forming the tapered thread connection pair are effectively entangled together, the outer cylindrical body, that is, the nut body that is not adjacent to the fastened workpiece, can stay and/or be removed according to the application conditions, leaving only one nut (for example, if there is a requirement for lightweight equipment or no double nuts to ensure the reliability of the connection technology and other application fields). The removed nut body is not used as a connecting nut but only an installation process nut. The internal thread of the installation process nut can not only be made of bidirectional tapered threads, but also unidirectional tapered threads and other threads that can be screwed with tapered threads, including non-tapered threads such as triangular threads, trapezoidal threads, and sawtooth threads. The reliability of the connection technology should be ensured. The conical connection pair is a closed-loop fastening technology system. That is, when the internal thread and the external thread of the tapered thread connection pair are effectively entangled together, the tapered conical connection pair will become an independent technical system without relying on the technical compensation of the third party to ensure the technical effectiveness. That is, even if there is no support from other objects, including the gap between the tapered thread connection pair and the fastened workpiece, it will not affect the effectiveness of the tapered thread connection pair. This will help greatly reduce the equipment weight, remove the dead load, and improve the equipment's effective load capacity, braking performance, energy saving and emission reduction, and other technical requirements. This is the unique thread technology advantage of the tapered thread connection pair of the connection structure of bolt and nut with the bidirectional tapered thread, regardless of whether the relationship with the fastened workpieces is non-rigid or rigid connection. Other thread technologies can not be provided with this advantage.

The bolt and nut with bidirectional tapered thread are connected in transmission through the screw connection of the bidirectional tapered hole and the bidirectional truncated cone body, and the load is bidirectional. When the external thread and the internal thread form a thread pair, there must be a clearance between the bidirectional truncated cone body and the bidirectional tapered hole. If oil and other media are lubricated between the internal thread and the external thread, it will easily form a bearing oil film. The clearance is conducive to the formation of the bearing oil film. The bolt and nut with bidirectional tapered thread, applied to the transmission connection, are equivalent to a group of sliding bearing pairs composed of one pair and/or several pairs of sliding bearings. In other words, each section of bidirectional conical internal thread bidirectionally contains a corresponding section of bidirectional conical external thread to form a pair of sliding bearing, and the number of sliding bearings is adjusted according to the application conditions. In other words, the effective bidirectional joint of the bidirectional conical internal thread and the bidirectional conical external thread, that is, thread pitches of the effective contact envelopment of the containment and contained, should be designed according to the application conditions. By the bidirectional tapered hole containing the bidirectional truncated cone body, radial, axial, angular, circumferential and so on, the multi-directional positioning is achieved. Preferably, by the bidirectional tapered hole containing the bidirectional truncated cone body, the radial and circumferential as main positioning, the axial and angular as auxiliary positioning, the multi-directional positioning is supplemented until the conical surface of the bidirectional tapered hole and the conical surface of the bidirectional truncated cone body are enclosed to achieve self-positioning or until the sizing interference contact to achieve self-locking. This produces a special composite technology of the cone pair and the thread pair to ensure the tapered thread technology, especially transmission connection accuracy, efficiency and reliability of the connection structure of bolt and nut with bidirectional tapered thread.

For the bolt and nut with bidirectional tapered thread, the fastened and sealed technical performance is realized by the screw connection of the bidirectional tapered hole and the bidirectional truncated cone body, that is, by the first helical conical surface of the tapered hole and the first helical conical surface of the truncated cone body sizing interference and/or the second helical conical surface of the tapered hole and the second helical conical surface of the truncated cone body sizing interference. According to the application conditions, that achieves load in one direction and/or load in two directions simultaneously. With the bidirectional truncated cone body and the bidirectional tapered hole guided by the helical line, the inner and outer diameters of inner and outer cone are centered until the first helical conical surface of the tapered hole encloses with the first helical conical surface of the truncated cone body to achieve load in one direction or in two directions at the same time sizing cooperation or until sizing interference contact. And/or the inner and outer diameters of inner and outer cone are centered until the second helical conical surface of the tapered hole encloses with the second helical conical surface of the truncated cone body to achieve load in one direction or in two directions at the same time sizing cooperation or until sizing interference contact. In other words, By the self-locking of the bidirectional tapered hole containing the bidirectional truncated cone body, radial, axial, angular, circumferential and so on, the multi-directional positioning is achieved. Preferably, by the bidirectional tapered hole containing the bidirectional truncated cone body, the radial and circumferential as main positioning, the axial and angular as auxiliary positioning, the multi-directional positioning is supplemented until the conical surface of the bidirectional tapered hole and the conical surface of the bidirectional truncated cone body are enclosed to achieve self-positioning or until the sizing interference contact achieve self-locking. This produces a special composite technology of the cone pair and the thread pair to ensure the tapered thread technology, especially the efficiency and reliability of the bolt and nut with bidirectional tapered thread, thereby to achieve the technical performance of mechanical mechanism connection, locking, anti-loosening, bearing, fatigue and sealing.

Therefore, for the bolt and nut with bidirectional tapered thread, the technical performances such as the transmission precision and efficiency, the load bearing capacity, the locking force of self-locking, the anti-loosening ability and the sealing performance of the bidirectional tapered thread technology are related to the sizes of the first helical conical surface of the truncated cone body and the formed left taper, i.e., the first taper angle α1, the second helical conical surface of the truncated cone body and the formed right taper, i.e., the second taper angle α2, the first helical conical surface of the tapered hole and the formed left taper, i.e., the first taper angle α1, as well as the second helical conical surface of the tapered hole and the formed right taper, i.e., the second taper angle α2. Material friction coefficient, processing quality and application conditions of the columnar body and the cylindrical body also have a certain impact on the cone fit.

For the bolt and nut with bidirectional tapered thread, when the right-angled trapezoid union rotates a circle at a constant speed, an axial movement distance of the right-angled trapezoid union is at least double a length of the sum of the right-angled sides of the two right-angled trapezoids with the same lower sides and upper sides and same right-angled side and/or different right-angled sides. The structure ensures that the first helical conical surface and the second helical conical surface of the truncated cone body as well as the first helical conical surface and the second helical conical surface of the tapered hole have sufficient length, thereby ensuring that the conical surface of the bidirectional truncated cone body and the conical surface of the bidirectional tapered hole have sufficient effective contact area and strength and the efficiency required by helical movement during fitting.

For the bolt and nut with bidirectional tapered thread, when the right-angled trapezoid union rotates a circle at a constant speed, an axial movement distance of the right-angled trapezoid union is equal to a length of the sum of the right-angled sides of two right-angled trapezoids with the same lower sides and upper sides and same right-angled side and/or different right-angled sides. The structure ensures that the first helical conical surface of the truncated cone body and the second helical conical surface of the truncated cone body as well as the first helical conical surface of the tapered hole and the second helical conical surface of the tapered hole have sufficient length, thereby ensuring that the conical surface of the bidirectional truncated cone body and the conical surface of the bidirectional tapered hole have sufficient effective contact area and strength and the efficiency required by helical movement during fitting.

For the above-mentioned bolt and nut with bidirectional tapered thread, the first helical conical surface of the truncated cone body and the second helical conical surface of the truncated cone body are both continuous helical surfaces or discontinuous helical surfaces; The first helical conical surface of the tapered hole and the second helical conical surface of the tapered hole are both continuous helical surfaces or discontinuous helical surfaces.

For the above-mentioned bolt and nut with bidirectional tapered thread, when the cylindrical body connecting hole is screwed into the screw-in end of the columnar body, there is a screw-in direction requirement, that is, the cylindrical body connecting hole cannot be rotated in the opposite direction into the screw-in end of the columnar body.

For the above-mentioned bolt and nut with bidirectional tapered thread, one end of the columnar body is provided with a head having a size larger than the outer diameter of the columnar body, and/or one and/or both ends of the columnar body are provided with a head having a size smaller than the small diameter of the external bidirectional tapered thread of the columnar body screw body. The connecting hole is a threaded hole provided in the nut. That is to say, the columnar body and the head are connected as bolt. The columnar body without the head, and/or the columnar body with the heads at both ends which are smaller than the small diameter of the external bidirectional tapered thread, and/or the columnar body with no-thread in the middle and external bidirectional tapered threads at both ends, are the studs. The connecting hole is arranged in the nut.

Compared with the existing technology, the connection structure of bolt and nut with bidirectional tapered thread have the advantages of reasonable design, simple structure, convenient operation, large locking force, high bearing capacity, excellent anti-loosening performance, high transmission efficiency and precision, good mechanical sealing effect and good stability, realizes the fastening and connecting functions through bidirectional bearing or sizing of the cone pair formed by coaxially aligning the inner diameter and the outer diameter of the internal cone and the external cone to achieve interference fit, can prevent loosening phenomenon during connection, and has self-locking and self-positioning functions.

### BRIEF DESCRIPTION OF THE DRAWINGS

FIG. 1 is a schematic diagram of a connection structure of a bolt and double nuts with a dumbbell-like shape (the taper on the left is smaller than the taper on the right) asymmetric bidirectional tapered thread according to embodiment 1 of the present disclosure.

FIG. 2 is a schematic diagram of the bolt with the external thread of the dumbbell-like shape (the taper on the left is smaller than the taper on the right) bidirectional tapered thread and the complete unit thread of external thread according to the embodiment 1 of the present disclosure.

FIG. 3 is a schematic diagram of the bolt with the internal thread of the dumbbell-like shape (the taper on the left is smaller than the taper on the right) bidirectional tapered thread and the complete unit thread of internal thread according to the embodiment 1 of the present disclosure.

FIG. 4 is a schematic diagram of a connection structure of a bolt and a single nut with a dumbbell-like shape (the taper on the left is smaller than the taper on the right) asymmetric bidirectional tapered thread according to embodiment 2 of the present disclosure.

FIG. 5 is a schematic diagram of a connection structure of a bolt and double nuts with a dumbbell-like shape (the taper on the left is smaller than the taper on the right) asymmetric bidirectional tapered thread according to embodiment 3 of the present disclosure.

FIG. 6 is a schematic diagram of a connection structure of a bolt and double nuts (there is a washer between the double nuts) with a dumbbell-like shape (the taper on the left is smaller than the taper on the right) asymmetric bidirectional tapered thread according to embodiment 4 of the present disclosure.

FIG. 7 is an illustration of “the thread of the existing thread technology is an inclined plane on a cylindrical or conical surface” involved in the background technology of the present disclosure.

FIG. 8 is an illustration of the “an inclined plane slider model of the principle of the existing thread technology—the principle of inclined plane” involved in the background technology of the present disclosure.

FIG. 9 is an illustration of the “a thread rise angle of the existing thread technology” involved in the background technology of the present disclosure.

In the figure, tapered thread 1, cylindrical body 2, nut body 21, nut body 22, columnar body 3, screw body 31, tapered hole 4, bidirectional tapered hole 41, bidirectional conical surface 42 of the tapered hole, first helical conical surface 421 of the tapered hole, first taper angle α1, second helical cone surface of the tapered hole 422, second taper angle α2, internal helical line 5, internal thread 6, truncated cone body 7, bidirectional truncated cone body 71, conical surface 72 of the truncated cone body, first helical cone surface of the truncated cone body 721, first taper angle α1, first helical conical surface 721 of the truncated cone body, second taper angle α2, external helical line 8, external thread 9, dumbbell-like shape 94, left taper 95, right taper 96, left-direction distribution 97, right-direction distribution 98, thread connection pair and/or thread pair 10, clearance 101, locking supporting surface 111, locking supporting surface 112, tapered thread supporting surface 122, tapered thread supporting surface 121, workpiece 130, nut body locking direction 131, washer 132, cone axis 01, thread axis 02, slider A on the inclined surface, inclined surface B, gravity G, gravity component Gi along the inclined surface component, friction force F, thread rise angle φ, equivalent friction angle P, major diameter d of traditional external thread, small diameter d1 of traditional external thread, pitch diameter d2 of traditional external thread.

### DETAILED DESCRIPTION OF EMBODIMENTS

The present disclosure will be further described in detail below with reference to the drawings and specific embodiments.

### Embodiment 1

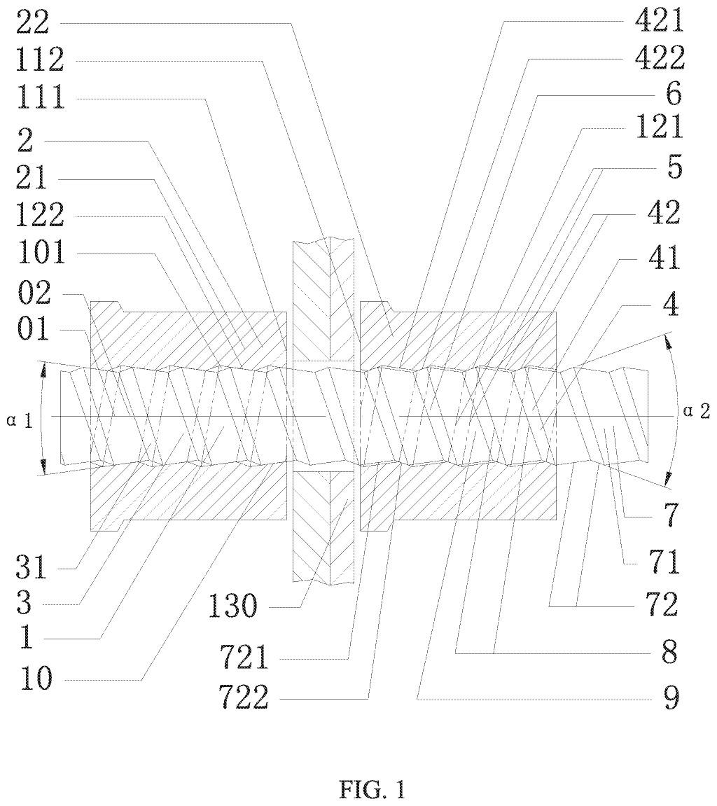

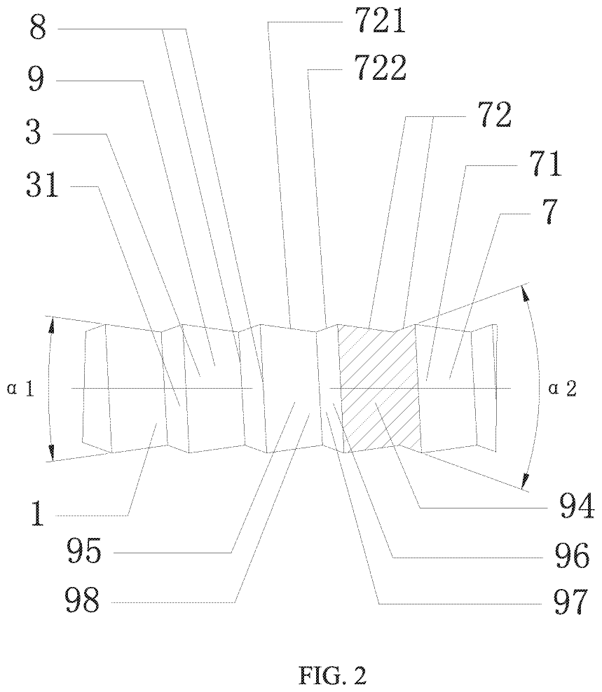

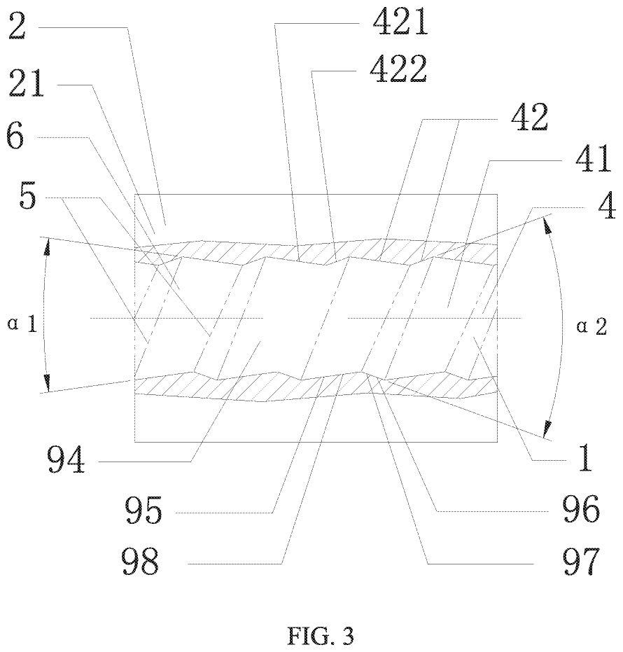

As shown in FIG. 1, FIG. 2, and FIG. 3, the present embodiment adopts the connection structure of a bolt and double nut comprises a bidirectional truncated cone body 71 helically distributed on an outer surface of a columnar body 3 and a bidirectional tapered hole 41 helically distributed in an inner surface of a cylindrical body 2, namely, comprises an external thread 9 and an internal thread 6 which are in mutual thread fit. The internal thread 6 is distributed as a helical bidirectional tapered hole 41; and the external thread 9 is distributed as a helical bidirectional truncated cone body 71. The internal thread 6 presents the helical bidirectional tapered holes 41 and exists in the form of “non-entity space”; and the external thread 9 presents the helical bidirectional truncated cone bodies 71 and exists in the form of “material entity”. The internal thread 6 and the external thread 9 are subjected to a relationship of containing part and contained part as follows: the internal thread 6 and the external thread 9 are fitted together by screwing bidirectional tapered geometries pitch by pitch and cohered till an interference fit is achieved, i.e., the bidirectional tapered hole 41 contains the bidirectional truncated cone body 71 pitch by pitch. The bidirectional containment limits a disordered degree of freedom between the tapered hole 4 and the truncated cone body 7; and the helical movement enables the thread connection pair 10 of the bidirectional tapered thread technology to obtain a necessary ordered degree of freedom. This effectively synthesizes the technical characteristics of the cone pair and the thread pair.

For the bolt and nut with bidirectional tapered thread in this embodiment, the thread connection pair 10 in the present embodiment has the self-locking and self-positioning performances only if the truncated cone body 7 and/or the tapered hole 4 reaches a certain taper, i.e., cone bodies forming the cone pair reach a certain taper angle. The taper comprises a left taper 95 and a right taper 96. The taper angle comprises a left taper angle and a right taper angle. In the present embodiment, the left taper 95 and the right taper 96 are the same or approximately the same, and the tapered thread comprises an asymmetric bidirectional tapered thread 1 having an olive-like shape 93 and an asymmetric bidirectional tapered thread 1 having a dumbbell-like shape 94. The left taper 95 corresponds to the left taper angle, i.e., a first taper angle α1. It is preferable that the first taper angle α1 is greater than 0° and smaller than 53°; and preferably, the first taper angle α1 is 2°-40°. The right taper 96 corresponds to the right taper angle, i.e., a second taper angle α2. It is preferable that the second taper angle α2 is greater than 0° and smaller than 53°; and preferably, the second taper angle α2 is 2°-40°. In individual special fields, i.e., transmission connection application fields without self-locking and/or with low requirements on self-positioning performances and/or in which anti-lock measures are set, t is preferable that the first taper angle α1 is greater than or equal to 53 and smaller than 180°, and the second taper angle α2 is greater than or equal to 53 and smaller than 180°. It is preferable that the first taper angle α1 is greater than or equal to 530 and smaller than and equal to 90°; and the second taper angle α2 is greater than or equal to 530 and smaller than and equal to 90°.

The external thread 9 is arranged on the outer surface of the columnar body 3, wherein the columnar body 3 is provided with a screw body 31; the truncated cone body 7 is helically distributed on the outer surface of the screw body 31; and the truncated cone body 7 comprises the asymmetric bidirectional truncated cone body 71. The asymmetric bidirectional truncated cone body is a special bidirectional tapered geometry in the dumbbell-like shape 94. The columnar body 3 may be solid or hollow, comprising workpieces and objects like cylinders, cones and tubes that need to be machined with threads on outer surfaces thereof.

The asymmetric bidirectional truncated cone body 71 in the dumbbell-like shape 94, i.e., the external thread, is formed by symmetrically and oppositely jointing the upper top surfaces of two same truncated cone bodies, and the lower bottom surfaces are located at both ends of the bidirectional truncated cone body 71 to form the asymmetric bidirectional tapered thread 1, comprising that the lower bottom surfaces of the bidirectional truncated cone body 71 are respectively jointed with the lower bottom surfaces of the adjacent bidirectional truncated cone bodies 71 and/or to be respectively jointed with the lower bottom surfaces of the adjacent bidirectional truncated cone bodies 71. The external thread 9 comprises a first helical conical surface 721 of the truncated cone body as well as a second helical conical surface 722 of the truncated cone body and an outer helical line 8 so as to form an asymmetric bidirectional tapered external thread 9. In a cross section through which the thread axis 02 passes, a complete single-pitch asymmetric bidirectional tapered external thread 9 is a special bidirectional tapered geometry in the dumbbell-like shape 94 small in the middle and large in both ends. The asymmetric bidirectional truncated cone body 71 comprises a conical surface 72 of the asymmetric bidirectional truncated cone body. The angle formed between the two plain lines of the left conical surface of the asymmetric bidirectional truncated cone body 71, i.e., the first helical conical surface 721 of the truncated cone body, is the first taper angle α1. The left taper 95 is formed on the first helical conical surface 721 of the truncated cone body and is subjected to a right-direction distribution 98. The angle formed by the two plain lines of the right conical surface of the asymmetric bidirectional truncated cone body 71, i.e., the second helical conical surface 722 of the truncated cone body, is the second taper angle α2. The right taper 96 is formed on the second helical conical surface 722 of the truncated cone body and is subjected to a left-direction distribution 97. The taper directions corresponding to the first taper angle α1 and the second taper angle α2 are opposite. The plain line is an intersection line of the conical surface and the plane through which the cone axis 01 passes. The shape formed by the first helical conical surface 721 and the second helical conical surface 722 of the truncated cone body of the bidirectional truncated cone body 71 is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the columnar body 3, wherein the right-angled side is coincident with the central axis of the columnar body 3. The right-angled trapezoid union refers to a special geometry, which is formed by symmetrically and oppositely jointing the upper sides of two same right-angled trapezoids and has the lower sides respectively located at both ends of the right-angled trapezoid union.

The internal thread 6 is arranged in the inner surface of the cylindrical body 2, wherein the cylindrical body 2 comprises a nut body 21 and a nut body 22; the tapered hole 4 is helically distributed in the inner surfaces of the nut body 21 and the nut body 22; and the tapered hole 4 comprises the asymmetric bidirectional tapered holes 41. The cone hole 4 includes the asymmetric bidirectional cone hole 41. The asymmetric bidirectional cone hole 41 is a special dumbbell-like shape 94 bidirectional cone geometry. The cylindrical body 2 comprises cylindrical and/or non-cylindrical workpieces and objects which need to be machined with the internal threads in the inner surfaces.

The asymmetric bidirectional tapered hole 41 in the dumbbell-like shape 94, i.e., the internal thread, is formed by symmetrically and oppositely jointing the upper top surfaces of two same tapered holes, and the lower bottom surfaces are located at both ends of the bidirectional tapered hole 41 to form the asymmetric bidirectional tapered thread 1, comprising that the lower bottom surfaces of the bidirectional tapered hole 41 are respectively jointed with the lower bottom surfaces of the adjacent bidirectional tapered holes 41 and/or to be respectively jointed with the lower bottom surfaces of the adjacent bidirectional tapered holes 41. The internal thread 6 comprises a first helical conical surface 421 of the tapered hole as well as a second helical conical surface 422 of the tapered hole and an inner helical line 5 so as to form the asymmetric bidirectional tapered internal thread 6. In the cross section passing through the thread axis 02, the complete single-pitch asymmetric bidirectional tapered internal thread 6 is a special bidirectional tapered geometry in the dumbbell-like shape 94 and with a small middle and two large ends. The asymmetric bidirectional tapered holes 41 include conical surfaces 42 of the asymmetric bidirectional tapered holes. The angle formed between the two plain lines of the left conical surface of the asymmetric bidirectional tapered hole 41, i.e., the first helical conical surface 421 of the tapered hole, is the first taper angle α1. The left taper 95 is formed on the first helical conical surface 421 of the tapered hole and is subjected to a right-direction distribution 98. The angle formed by the two plain lines of the right conical surface of the asymmetric bidirectional tapered hole 41, i.e., the second helical conical surface 422 of the tapered hole, is the second taper angle α2. The right taper 96 is formed on the second helical conical surface 422 of the tapered hole and is subjected to a left-direction distribution 97. The taper directions corresponding to the first taper angle α1 and the second taper angle α2 are opposite. The plain line is an intersection line of the conical surface and the plane through which the cone axis 01 passes. The shape formed by the first helical conical surface 421 and the second helical conical surface 422 of the tapered hole of the bidirectional tapered hole 41 is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the cylindrical body 2, wherein the right-angled side is coincident with the central axis of the cylindrical body 2. The right-angled trapezoid union refers to a special geometry, which is formed by symmetrically and oppositely jointing the upper sides of two same right-angled trapezoids and has the lower sides respectively located at both ends of the right-angled trapezoid union.

This embodiment adopts the connection structure of a bolt and double nuts. The double nuts include a nut body 21 and a nut body 22. The nut body 21 is located on the left side of the fastened workpiece 130, and the nut body 22 is located on the right side of the fastened workpiece 130. When the bolt and the double nuts works, the relationship with the workpiece 130 to be fastened is a rigid connection. The rigid connection means that the end face supporting surface of nuts and supporting surface of the workpiece 130 are mutually supporting surfaces, including the locking supporting surface 111 and the locking supporting surface 112. The workpiece 130 refers to the connected object including the workpiece 130.

The working supporting surface of the thread in the embodiment is different, including the tapered thread support surface 121 and the tapered thread supporting surface 122. When the cylindrical body 2 is located on the left of the fastened workpiece130, that is, when the left end face of the fastened workpiece 130 and the right end face of the cylindrical body2, that is, the left nut body 21 are locking supporting surface 111 of the left nut body 21 and the fastened workpiece 130, the left helical conical surface of the bidirectional tapered thread 1 of the left nut body 21 and columnar body 3, that is, the bolt body 31 or bolt, is the thread working supporting surface. In other words, the first conical surface of the tapered hole 421 and the first helical conical surface of the truncated cone body 721 are the supporting surface of the tapered thread 122. The first conical surface of the tapered hole 421 and the first helical conical surface of the truncated cone body 721 are mutually the supporting surfaces. When the cylindrical body 2 is located on the right of the fastened workpiece130, that is, when the right end face of the fastened workpiece 130 and the left end face of the cylindrical body2, that is, the right nut body 22 are locking supporting surface 112 of the right nut body 22 and the fastened workpiece 130, the right helical conical surface of the bidirectional tapered thread 1 of the right nut body 22 and columnar body 3, that is, the bolt body 31 or bolt, is the thread working supporting surface. In other words, the second conical surface of the tapered hole 422 and the second helical conical surface of the truncated cone body 722 are the supporting surface of the tapered thread 121. The second conical surface of the tapered hole 422 and the second helical conical surface of the truncated cone body 722 are mutually the supporting surfaces.

The bolt and nut with bidirectional tapered thread are connected in transmission through the screw connection of the bidirectional tapered hole 41 and the bidirectional truncated cone body 71, and the load is bidirectional. When the external thread 9 and the internal thread 6 form a thread pair 10, there must be a clearance 101 between the bidirectional truncated cone body 71 and the bidirectional tapered hole 41. If oil and other media are lubricated between the internal thread 6 and the external thread 9, it will easily form a bearing oil film. The clearance is conducive to the formation of the bearing oil film. The tapered thread connection pair, are equivalent to a group of sliding bearing pairs composed of one pair and/or several pairs of sliding bearings. In other words, each section of bidirectional conical internal thread 6 bidirectionally contains a corresponding section of bidirectional conical external thread 9 to form a pair of sliding bearing, and the number of sliding bearings composed is adjusted according to the application conditions. In other words, thread pitches of the effective bidirectional joint of the bidirectional conical internal thread 6 and the bidirectional conical external thread 9, that is, the effective contact envelopment of the containment and contained, should be designed according to the application conditions. By the bidirectional tapered hole 4 containing the bidirectional truncated cone body 7, radial, axial, angular, circumferential and so on, the multi-directional positioning is achieved. This produces a special composite technology of the cone pair and the thread pair to ensure the tapered thread technology, especially transmission connection accuracy, efficiency and reliability of the connection structure of bolt and nut with bidirectional tapered thread.

For the bolt and nut with bidirectional tapered thread, the fastened and sealed technical performance is realized by the screw connection of the bidirectional tapered hole 41 and the bidirectional truncated cone body 71, that is, by the first helical conical surface of the tapered hole 721 and the first helical conical surface of the truncated cone body 421 sizing interference and/or the second helical conical surface of the tapered hole 722 and the second helical conical surface of the truncated cone body 422 sizing interference. According to the application conditions, loading in one direction and/or loading in two directions simultaneously is achieved. That is, with the bidirectional truncated cone body 71 and the bidirectional tapered hole 41 guided by the helical line, the inner and outer diameters of inner and outer cone are centered until the first helical conical surface of the tapered hole 421 encloses the first helical conical surface of the truncated cone body 721 to achieve loading in one direction or in two directions at the same time sizing cooperation or until sizing interference contact. Thereby, to the technical performance of mechanical mechanism connection, locking, anti-loosening, bearing, fatigue and sealing is achieved.

Therefore, for the bolt and nut with bidirectional tapered thread in this embodiment, the technical performance of transmission accuracy and efficiency, bearing capacity, self-locking locking force, anti-loosening capacity, and sealing is related to the first helical conical surface of the truncated cone body 721 and its left taper 95, that is, the first taper angle α1, the second helical conical surface of the truncated cone body 722 and its right taper 96, that is, the second taper angle α2, the first helical conical surface of the tapered hole 421 and its left taper 95, that is, the first taper angle α1, and the second helical conical surface of the tapered hole 422 and its right taper 96, that is, the second taper angle α2. The material friction coefficient, processing quality and application conditions of the columnar body 3 and the cylindrical body 2 also have a certain influence on the cone fit.

For the above-mentioned bolt and nut with bidirectional tapered thread, when the right-angled trapezoid union rotates a circle at a constant speed, the axial movement distance of the right-angled trapezoid union is at least double the length of the sum of the right-angled sides of two same right-angled trapezoids. The structure ensures that the first helical conical surface 721 and the second helical conical surface 722 of the truncated cone body as well as the first helical conical surface 421 and the second helical conical surface 422 of the tapered hole have sufficient length, thereby ensuring that the conical surface 72 of the bidirectional truncated cone body and the conical surface 42 of the bidirectional tapered hole have sufficient effective contact area and strength and the efficiency required by helical movement during fitting.

For the above-mentioned bolt and nut with bidirectional tapered thread, when the right-angled trapezoid union rotates a circle at a constant speed, the axial movement distance of the right-angled trapezoid union is equal to the length of the sum of the right-angled sides of two same right-angled trapezoids. The structure ensures that the first helical conical surface 721 and the second helical conical surface 722 of the truncated cone body as well as the first helical conical surface 421 and the second helical conical surface 422 of the tapered hole have sufficient length, thereby ensuring that the conical surface 72 of the bidirectional truncated cone body and the conical surface 42 of the bidirectional tapered hole have sufficient effective contact area and strength and the efficiency required by helical movement during fitting.

For the above-mentioned bolt and nut with bidirectional tapered thread, the first helical conical surface of the truncated cone body 721 and the second helical conical surface of the truncated cone body 722 are both continuous helical surfaces or discontinuous helical surfaces; The first helical conical surface of the tapered hole 421 and the second helical conical surface of the tapered hole 422 are both continuous helical surfaces or discontinuous helical surfaces.

For the above-mentioned bolt and nut with bidirectional tapered thread, when the cylindrical body 2 connecting hole is screwed into the screw-in end of the columnar body 3, there is a screw-in direction requirement, that is, the cylindrical body connecting hole cannot be rotated in the opposite direction into the screw-in end of the columnar body 2.

For the above-mentioned bolt and nut with bidirectional tapered thread, one end of the columnar body 3 is provided with a head having a size larger than the outer diameter of the columnar body 3, and/or one and/or both ends of the columnar body 3 are provided with a head having a size smaller than the small diameter of the external tapered thread 9 of the columnar body 3 screw body 31. The connecting hole is a threaded hole provided in the nut body 21. That is to say, the columnar body 3 and the head are connected as bolt. The columnar body without the head, and/or the columnar body with the heads at both ends which are smaller than the small diameter of the bidirectional external tapered thread, and/or the columnar body with no-thread in the middle and bidirectional external tapered threads at both ends are the studs. The connecting hole is arranged in the nut body 21.

Compared with the existing technology, the advantages of the conical connection pair 10 with the connection structure of bolt and nut with bidirectional tapered thread are: reasonable design, simple structure, the function of fastening and connection realized by the bidirectional load-bearing of cone pair which is formed by the inner and outer coaxial diameters positioning of the inner and outer cone or sizing interference cooperation, convenient operation, large locking force, large bearing value, good anti-loosening performance, high transmission efficiency and precision, good mechanical sealing effect, good stability, prevention of loose phenomenon of connection, and self-locking and self-positioning functions.

### Embodiment 2

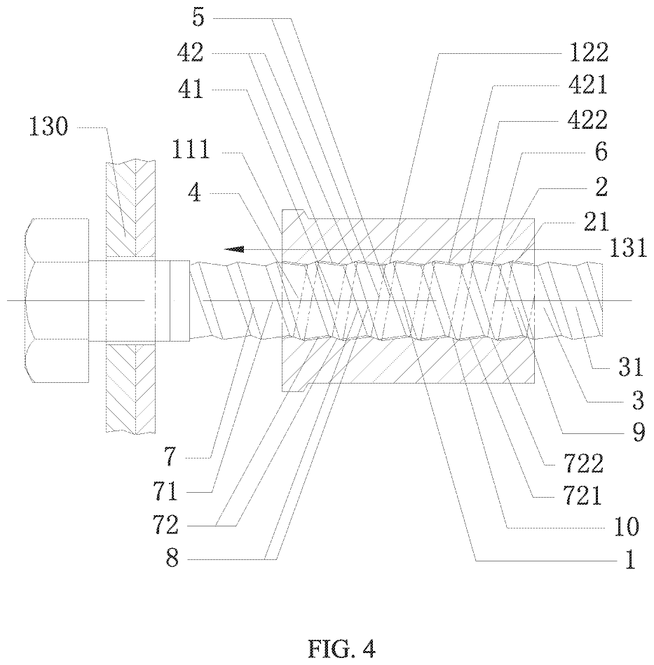

As shown in FIG. 4, the structure, principle, and implementation steps of this embodiment are similar to those of Embodiment 1. The difference is that this embodiment adopts a connection structure of a bolt and single nut, and the bolt body has a hexagonal head larger than the screw body 31. When the hexagonal head of the bolt is located on the left side, the cylindrical body 2, that is the nut body 21 or the single nut, is located on the right side of the fastened workpiece 130. When the connection structure of a bolt and single nut in this embodiment works, the relationship with the fastened workpiece 130 is also a rigid connection. The rigid connection means that the opposite end surfaces of the end face of the nut body 21 and the end face of the workpiece 130 are mutually supporting surfaces, and the supporting surface is the locking supporting surface 111. The workpiece 130 refers to a connected object including the workpiece 130.

The tapered thread working supporting surface of this embodiment is the tapered thread support surface 122. In other words, the cylindrical body 2, that is, the nut body 21 or the single nut, is located on the right side of the fastened workpiece 130. When the connection structure of the bolt and single nut works, the right end surface of the workpiece 130 and the left end surface of the nut body 21 are the locking supporting surface 111 of the nut body 21 and the fastened workpiece 130. The right helical conical surface of the bidirectional tapered thread 1 of the nut body 21 and columnar body 3, that is, the bolt body 31 or bolt, is the thread working supporting surface. In other words, the second conical surface of the tapered hole 422 and the first helical conical surface of the truncated cone body 722 are the supporting surface of the tapered thread 122. The second conical surface of the tapered hole 422 and the second helical conical surface of the truncated cone body 722 are mutually the supporting surfaces.

In this embodiment, when the hexagon head of the bolt is located on the right side, its structure, principle and implementation steps are similar to this embodiment.

### Embodiment 3

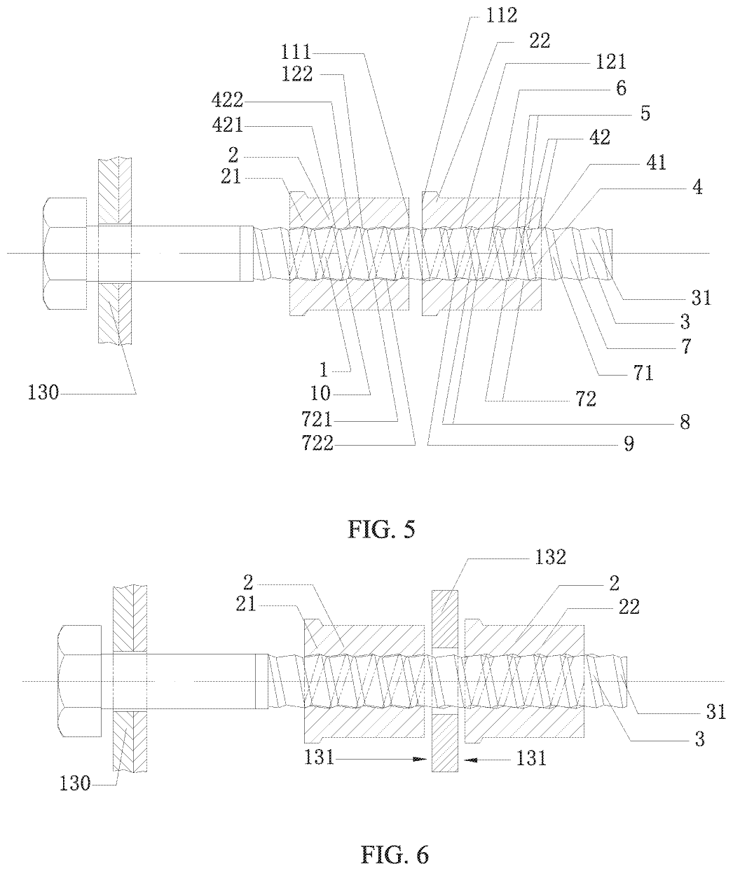

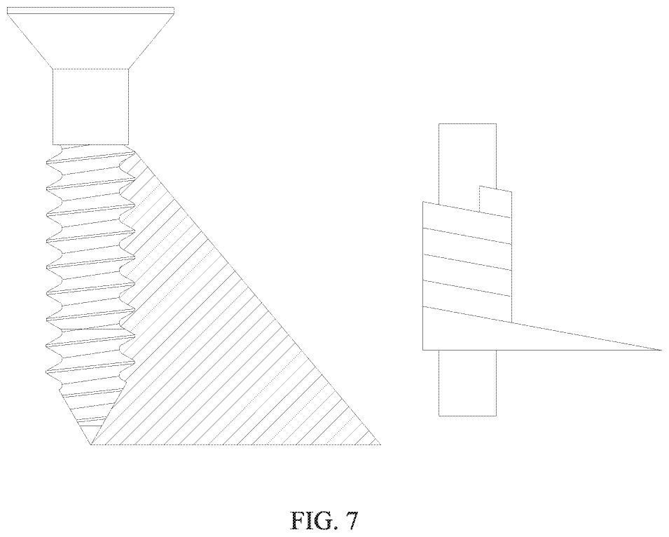

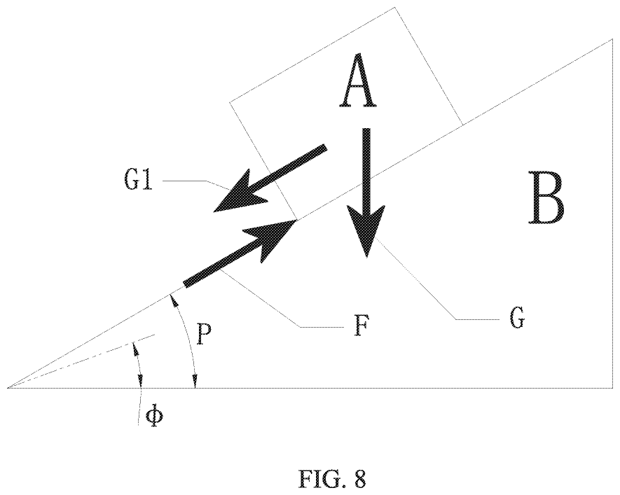

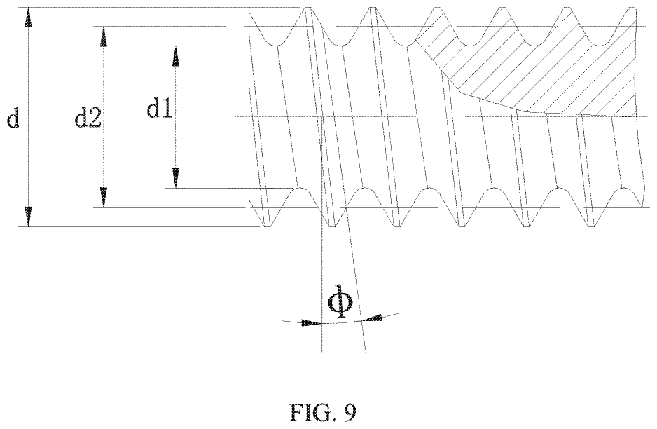

As shown in FIG. 5, the structure, principle, and implementation steps of this embodiment are similar to those of Embodiment 1. The difference is the positional relationship between the double nuts and the fastened workpiece 130. The double nuts include the nut body 21 and the nut body 22, and the bolt body has a hexagonal head larger than the screw body 31. When the hexagonal head of the bolt is located on the left side, the nut body 21 and the nut body 22 are located on the right side of the fastened workpiece 130. When the connection structure of a bolt and double nuts in this embodiment works, the relationship between the nut body 21, the nut body 22 and the fastened workpiece 130 is a non-rigid connection. The non-rigid connection means that the opposite end surfaces of the end face of the nut body 21, the nut body 22 are mutually supporting surfaces, and the supporting surfaces are the locking supporting surface 111 and the locking supporting surface 112. The workpiece 130 refers to a connected object including the workpiece 130.

The working supporting surface of the thread in this embodiment is different, including the tapered thread support surface 121 and the tapered thread supporting surface 122. The cylindrical body 2 includes the left nut body 21 and the right nut body 22. The right end face of the left nut body 21 is the locking supporting surface 111. The left end face of the right nut body 22 is the locking supporting surface 112. The locking supporting surface 111 and the locking supporting surface 112 contact each other oppositely and act as locking bearing surfaces mutually. When the right end face of the left nut body 21 is the locking supporting surface 111, the left helical conical surface of the bidirectional tapered thread 1 of the left nut body 21 and columnar body 3, that is, the bolt body 31 or bolt, is the thread working supporting surface. In other words, the first conical surface of the tapered hole 421 and the first helical conical surface of the truncated cone body 721 are the supporting surface of the tapered thread 122. The first conical surface of the tapered hole 421 and the first helical conical surface of the truncated cone body 721 are mutually the supporting surfaces. When the left end face of the right nut body 22 is the locking supporting surface 112, the right helical conical surface of the bidirectional tapered thread 1 of the right nut body 22 and columnar body 3, that is, the bolt body 31 or bolt, is the thread working supporting surface. In other words, the second conical surface of the tapered hole 422 and the second helical conical surface of the truncated cone body 722 are the supporting surface of the tapered thread 121. The second conical surface of the tapered hole 422 and the second helical conical surface of the truncated cone body 722 are mutually the supporting surfaces.

In this embodiment, when the inner cylindrical body 2, that is, the nut body 21 adjacent to the fastened workpiece 130, has been effectively combined with the columnar body 3, that is, the bolt body 31 or blot, the screw body, and in other words, when the internal thread 6 and the external thread 9 forming the tapered thread connection pair 10 are effectively entangled together, the outer cylindrical body 2, that is, the nut body 22 which is not adjacent to the fastened workpiece 130, can stay and/or be removed according to the application conditions, leaving only one nut (for example, if there is a requirement for lightweight equipment or no double nuts to ensure the reliability of the connection technology and other application fields). The removed nut body 22 is not used as a connecting nut but only used as an installation process nut. The internal thread of the installation process nut is not only made of bidirectional tapered threads, but also unidirectional tapered threads and other threads which can be screwed with tapered threads 1, including non-tapered threads such as triangular threads, trapezoidal threads, and sawtooth threads. The reliability of the connection technology should be ensured. The conical connection pair 10 is a closed-loop fastening technology system. That is, when the internal thread 6 and the external thread 9 of the tapered thread connection pair 10 are effectively entangled together, the tapered conical connection pair will become an independent technical system without relying on the technical compensation of the third party to ensure the technical effectiveness. That is, even if there is no support from other objects, including the gap between the tapered thread connection pair 10 and the fastened workpiece, it will not affect the effectiveness of the tapered thread connection pair 10. This will help greatly reduce the equipment weight, remove the dead load, and improve the equipment's effective load capacity, braking performance, energy saving and emission reduction, and other technical requirements. This is the unique thread technology advantage of the tapered thread connection pair 10 of the connection structure of bolt and nut with the bidirectional tapered thread, regardless of whether the relationship with the fastened workpiece 10 is non-rigid or rigid connection. And other thread technologies cannot be provided with this advantage.

In this embodiment, when the hexagon head of the bolt is located on the right side, the nut body 21 and the nut body 22 are both located on the left side of the fastened workpiece 130, and the structure, principle and implementation steps are similar to those of this embodiment.

### Embodiment 4

As shown in FIG. 6, the structure, principle, and implementation steps of this embodiment are similar to those of embodiment 1 and embodiment 3. The difference is that in this embodiment, on the basis of the third embodiment, a spacer such as a washer 132 is added between the nut body 21 and the nut body 22. In other word, the right end surface of the left nut body 21 and the right end surface of the left nut body 22 are in indirect contact with each other through the spacer and indirectly are mutually locking supporting surfaces. The relationship between the right end face of the left nut body 21 and the left end face of the right nut body 22 is changed from the direct mutual locking supporting surfaces to the indirect mutual locking supporting surfaces.

The specific embodiments described herein are merely examples to illustrate the spirit of the present disclosure. Those skilled in the technical field to which the present disclosure pertains can make various modifications, additions or similar alternatives to the specific embodiments described, but they will not deviate from the spirit of the present disclosure or exceed the definition range of the appended claims.

Although the terms are used in this article, such as tapered thread 1, cylindrical body 2, nut body 21, nut body 22, columnar body 3, screw body 31, tapered hole 4, bidirectional tapered hole 41, bidirectional conical surface 42 of the tapered hole, first helical conical surface 421 of the tapered hole, first taper angle α1, second helical cone surface of the tapered hole 422, second taper angle α2, internal helical line 5, internal thread 6, truncated cone body 7, bidirectional truncated cone body 71, bidirectional truncated cone body cone surface 72, first helical cone surface of the truncated cone body 721, first taper angle α1, second helical cone surface of the truncated cone body 722, second taper angle α2, external helical line 8, external thread 9, dumbbell-like shape 94, left taper 95, right taper 96, left-direction distribution 97, right-direction distribution 98, thread connection pair and/or thread pair 10, clearance 101, self-locking force, self-locking, self-positioning, pressure, cone axis 01, thread axis 02, mirrored, axis sleeve, axis, single cone body, double cones body, cone, internal cone, tapered hole, external cone, cone pair, helical structure, helical motion, threaded body, complete unit body thread, axial force, axial force angle, anti-axial force, anti-axial force angle, centripetal force, reverse central force, reverse collinearity, internal stress, bidirectional force, unidirectional force, sliding bearing, sliding bearing pair, locking supporting surface 111, locking supporting surface 112, tapered thread supporting surface 122, tapered thread supporting surface 121, non-solid space, material entity, workpiece 130, nut body locking direction 131, non-rigid connection, non-rigid material, transmission part and washer 132, they do not exclude the possibility of using other terms. These terms are used only to describe and explain the essence of the present disclosure more conveniently. To interpret them as any additional limitation is against the spirit of the present disclosure.

What is claimed is:

1. A connection structure of bolt and nut with dumbbell-like shape (a left taper is smaller than a right taper) bidirectional tapered thread, that is, a connection structure of bolt and nut with dumbbell-like shape (a left taper is smaller than a right taper) asymmetric bidirectional tapered thread, comprising an external thread(9) and an internal thread(6) threaded with each other, wherein a complete unit thread of the dumbbell-like shape (the left taper is smaller than the right taper) asymmetric bidirectional tapered thread is a helical dumbbell-like shape (94) bidirectional cone with small middle and big ends, and the left taper (95) the is smaller than the right taper (96); the above-mentioned complete unit thread comprises a bidirectional tapered hole (41) and a bidirectional truncated cone body (71);
a threaded body of the internal thread (6) is an inner surface of a cylindrical body (2) presenting as a helical bidirectional tapered hole (41) and exists in a form of “non-solid space”; a threaded body of the external thread (9) is an outer surface of a columnar body (3) presenting as the helical bidirectional truncated cone body (71) and exists in a form of “material entity”;
for the above-mentioned asymmetric bidirectional cone, the left conical surface forms the left taper (95) corresponding to the first taper angle (α1), the right conical surface forms the right taper (96) corresponding to the second taper angle (α2); the left taper (95) and right taper (96) are opposite and the taper is different; the above-mentioned internal thread (6) and external thread (9) bear each other by the tapered hole enclosing the cone; the technical performance mainly depends on the matching conical surfaces of threaded body and taper; preferably, 0°<the first taper angle (α1)<53°), 0°<the second taper angle (α2)<53°, for individual special fields, preferably, 53°≤the second taper angle (α2)<180°.

2. The connection structure according to claim 1, wherein the dumbbell-like shape (94) bidirectional internal thread (6) comprises a first helical conical surface (421) of the tapered hole, a second helical conical surface (422) of the tapered hole, and an internal helical line (5);
a third shape formed by the first helical conical surface (421) of the tapered hole and the second helical conical surface (422) of the tapered hole is the same as a shape of a helical outer flank of a second rotating body; wherein the second rotating body is formed by a second right-angled trapezoid union being rotated around a right-angled side of the second right-angled trapezoid union, and, at the same time, the second right-angled trapezoid union axially moves at a constant speed along the central axis of the cylindrical nut (2); wherein the second right-angled trapezoid union is formed by oppositely jointing two symmetrical upper sides of two right-angled trapezoids; wherein the two right-trapezoids have identical lower sides and upper sides, and same and/or different right-angled sides; wherein the two right-trapezoids are coincident with the central axis of the cylindrical nut (2);
the external thread (9) comprises a first helical conical surface (721) of the truncated cone body, a second helical conical surface (722) of the truncated cone body, and an external helical line (8);
a fourth shape formed by the first helical conical surface (721) of the truncated cone body and the second helical conical surface (722) of the truncated cone body, is the same as the shape of a helical outer flank of the second rotating body, wherein the second rotating body is formed by the second right-angled trapezoid union being rotated around the right-angled side of the second right-angled trapezoid union, and, at the same time, the second right-angled trapezoid union axially moves at constant speed along the central axis of the columnar body (3); wherein the second right-angled trapezoid union is formed by oppositely jointing two symmetrical upper sides of the two right-angled trapezoids; wherein the two right-trapezoids have identical lower sides and upper sides, and same and/or different right-angled sides; wherein the two right-trapezoids are coincident with the central axis of the columnar body (3).

3. The connection structure according to claim 2, wherein when the right-angled trapezoid union rotates a circle at a constant speed, an axial movement distance of the right-angled trapezoid union is at least double a length of the sum of the right-angled sides of the two right-angled trapezoids of the right-angled trapezoid union.

4. The connection structure according to claim 2, wherein when the right-angled trapezoid union rotates a circle at a constant speed, an axial movement distance of the right-angled trapezoid union is equal to a length of the sum of the right-angled sides of the two right-angled trapezoids of the right-angled trapezoid union.

5. The connection structure according to claim 1, wherein the first helical conical surface (421) of the tapered hole and the second helical conical surface (422) of the tapered hole, and the internal helical line (5) are continuous helical surfaces or discontinuous helical surfaces; and/or
the first helical conical surface (721) of the truncated cone body and the second helical conical surface (722) of the truncated cone body, and the external helical line (8) are continuous helical surfaces or discontinuous helical surfaces.

6. The connection structure according to claim 1, wherein the internal thread (6) is formed by oppositely jointing two symmetrical upper sides of two tapered holes (3), wherein the two tapered holes have identical lower sides and upper sides, and same and/or different taper height; wherein the lower sides of the two tapered holes are located at two ends of the bidirectional tapered holes (41), and are respectively jointed with the lower sides of the adjacent bidirectional tapered holes;
the external thread (9) is formed by oppositely jointing two symmetrical upper bottom sides of two truncated cone bodies, wherein the two truncated cone bodies have identical lower sides and upper sides, and same and/or different taper height; wherein the lower sides of the two truncated cone bodies are located at two ends of the bidirectional truncated cone body (41), and are respectively jointed with the lower sides of the adjacent bidirectional truncated cone bodies.

7. The connection structure according to claim 1, wherein the first helical cone surface of the tapered hole (421) and the second helical cone surface of the tapered hole (422), with the matching first helical cone surface of the truncated cone body (721) and matching second helical cone surface of the truncated cone body (722) take the contact surface as the supporting surface; under the guidance of the helical line, the inner and outer diameters of the inner cone and the outer cone of the thread pair (10) composed of the internal thread (6) and the external thread (9) are centered until the bidirectional tapered hole cone surface (42) and the bidirectional truncated cone body cone surface (72) are entangled so that the helical conical surface is loaded in one direction and/or two directions at the same time and/or until the sizing self-positioning contact and/or until the sizing interference contact producing self-locking.

8. The connection structure according to claim 1, wherein the connection structure of bolt and double nuts is provided with the nuts located on the left and right sides of the fastened workpiece and/or the connection structure of bolt and single nuts is provided with the single nut (21) located on the left or right side of the fastened workpiece, and/or the nuts located on the left and right sides of the fastened workpiece when the connection structure of bolt and double nuts is provided;
when a nut has been effectively combined with the bolt, that is, when the internal thread (6) and the external thread (9) forming the tapered threaded connection pair (10) are effectively entangled together, the other nut can be removed and/or retained; the nut removed is used as an installation process nut; its internal thread comprises the bidirectional tapered thread (1), one-way tapered thread, triangular thread, trapezoidal thread, sawtooth thread, rectangular thread, circular arc thread and others; these traditional threads meets the technical spirit of the present disclosure only when they are threaded to match the above-mentioned bidirectional conical external thread (9).

9. The connection structure according to claim 1, wherein when the cylindrical body (2) connecting hole is screwed into the screw-in end of the columnar body (3), there is a screw-in direction requirement, that is, the cylindrical body (2) connecting hole cannot be rotated in the opposite direction into the screw-in end of the columnar body (3); the connecting hole is a threaded hole set on the nut body (21) and the nut body (22); the connecting hole is set in the nut body (21) and the nut body (22); the nut refers to a object such as nut body whose the inner surface of the cylindrical body (2) has a threaded structure on including such as nut.

10. The connection structure according to claim 1, wherein the above-mentioned internal thread (6) and/or external thread (9) comprises a single thread body which is an incomplete conical geometry body, that is, a single thread body is an incomplete unit body thread.
